(19) United States
(12) Patent Application Publication
(10) Pub. No.: US 2015/0379065 A1
(43) Pub. Date: Dec. 31, 2015

(54) DATABASE SERVER STORING PLURALITY OF VERSIONS OF DATA, AND DATABASE MANAGEMENT METHOD

(71) Applicant: HITACHI, LTD., Chiyoda-ku, Tokyo (JP)

(72) Inventors: Masahiro YOSHIZAWA, Tokyo (JP); Tatsuya SATO, Tokyo (JP)

(73) Assignee: HITACHI, LTD., Tokyo (JP)

(21) Appl. No.: 14/768,078

(22) PCT Filed: May 10, 2013
(86) PCT No.: PCT/JP2013/063213

§ 371 Date: Aug. 14, 2015

(51) Int. Cl. G06F 17/30

(52) U.S. Cl. CPC G06F 17/30371; G06F 17/30554; G06F 17/30424; G06F 17/30312

(57) ABSTRACT

A database server includes a database capable of storing multi-version data with respect to various time-series data, and a database management server that manages the database. The database management server includes search means capable of designating a merge policy defining a policy whether mixing of the multi-version data is acceptable in addition to a search condition of the database. The search means generates a result of merging of the multi-version data in the time range contained in the search condition as the data acquisition history so as to be recorded in the database.

### TECHNICAL FIELD

The present invention relates to a database server and a database method, and more particularly, to a management technique of time-series data in the database server that stores multi-version data.

### BACKGROUND

The database server has a database therein, and a database management server and a database processor as the system for management of the database.

The technique for automatically deleting unnecessary time-series data from the database file is well known as the technique for managing the time-series data in the database.

Related art concerning the database for storing the multi-version data will be described below.

Patent Literature 1 discloses the data server provided with time-series data search means, unnecessary data deletion selection means and unnecessary data deletion means, and the method of deleting only the data of old version in the time range overlapped with the new time-series data among those with the old and new versions mixed on the database. The invention disclosed in Patent Literature 1 is intended to allow the time-series data to be retained in the same database file automatically at the required time point upon deletion of the unnecessary time-series data from the database file, and to further make it unnecessary for the external application program to check the version of the time-series data on the database.

Patent Literature 2 discloses the database processor which includes access selection means defining both the databases of old version and the database of new version, and capable of selecting the definition information of either the old or the new version in response to the access request. The device further includes a mechanism for rewriting the information of the old version to the new one.

### PATENT LITERATURE

### Patent Literature 1: JP-A-7-73086

### Patent Literature 2: JP No. 2503297

### SUMMARY OF THE INVENTION

### Technical Problem

A large-scale data center has demanded to partially automate and improve efficiency of monitoring operations by applying complicated process to the time-series data collected from the server device through combination of multiple automatic monitoring techniques. The aforementioned automatic process includes the process of detecting the sign of anomaly and the process of locating the root cause from multiple anomalies (Root Cause Analysis, hereinafter referred to as RCA), for example. For the future, combination of analysis programs for realizing the automatic process in multiple stages is expected to be generalized.

FIG. 20A is a schematic view showing that the time-series data before processing (raw data) are processed through multiple analysis programs in stages, and the processed data are stored in the database as the time-series data. For example, the “anomaly data” in the database resulting from the process through the “anomaly detection process” program as the analysis program are subjected to the RCA process as the subsequent process so that information on the anomaly data dependency is generated. Furthermore, the search index generation process is executed with respect to the “anomaly data” to generate the “anomaly data for search”.

When applying the automatic process to the actual operation site, algorithm and parameter for those analysis programs have to be reviewed on each occasion. The review of the algorithm and parameter will be referred to as version upgrading hereinafter. Version upgrading of the analysis program may change the result. Therefore, the operation of both new and old analysis programs in parallel, and storage of the analytical results generated by the old analysis program have to be conducted for a predetermined period subsequent to such review on the analysis program.

FIG. 20B is a schematic view of a generally employed version upgrading procedure of the analysis program. In this example, the data (anomaly data: (Ver. 1)) generated by processing the raw data through the analysis program “anomaly detection process” (Ver. 1) are used by the subsequent analysis program “RCA process” and “search index generation process”. For example, the data corresponding to the single process in the past are subjected to the “RCA process”, and the data (anomaly data: (Ver. 1)) corresponding to an annual volume in the past are subjected to the “search index generation process”. The analysis program such as the “RCA process” and “search index generation process” will be referred to as the subsequent process of the analysis program (in this example, “anomaly detection process”).

When version upgrading the analysis program with the subsequent process, that is, the “anomaly detection process” program from (Ver. 1) to (Ver. 2), the old analysis program (“anomaly detection process” of (Ver. 1)) and the new analysis program (“anomaly detection process” of (Ver. 2)) are operated in parallel as represented by (1) of FIG. 20B. Referring to (2) of FIG. 20B, the data read destination has to be changed at the side of the respective subsequent processes (“RCA process”, “search index generation process”) based on the judgment criteria for each of the subsequent processes. If the old analysis program is continuously operated, and the analytical results generated by the old analysis program still exist on the database, the usage of disk space on the database may be increased in accordance with the number of times of version upgrading.

The length of the time period continuously requiring the analytical results (“anomaly data” shown in FIG. 20B (Ver. 1)) generated by the old analysis program (Ver. 1) is variable depending on the subsequent process such as the “RCA process”. Deletion of the analytical results generated by the old analysis program without obtaining the confirmation from the developer of the subsequent process may adversely affect the subsequent process. However, if there are a large number of subsequent processes, and the subsequent process is executed in multiple stages, it is difficult for the developer of the subsequent process to correctly report about the analytical results which should be retained.

In the case where the subsequent process is executed in multiple stages, it is necessary to specify the use of the analytical results of the subsequent process in the previous stage followed by one or more subsequent process steps. In such a case, it becomes more difficult for the developer to provide the report. Accordingly, the developer of the subsequent process may report while providing the analytical results with a margin more than those actually required. In order to minimize the usage of disk space on the database, the method of deleting the unnecessary analytical results is required without depending on the report from the developer of the subsequent process.

According to the invention disclosed in Patent Literature 1, the database server is designed to determine all the data in the time range overlapped with the new time-series data as those to be deleted irrespective of contents of the subsequent process. Assuming that the invention disclosed in Patent Literature 1 is applied to management of the time-series data through combination of the multiple automatic monitoring techniques, the subsequent process may be adversely affected.

The invention disclosed in Patent Literature 2 provides the function for rewiring the information of the old version to the new one, but no means for locating the deletable data among those of old and new versions. In other words, the invention disclosed in Patent Literature 2 is not designed to delete the unnecessary time-series data.

It is an object of the present invention to provide a management technique of time-series data for automatically extracting deletable data among those generated by the old analysis program in the database server that stores the multi-version time-series data without depending on the information reported by the developer of the subsequent process.

### Means for Solving the Problem

As a representative example, the database server includes a database capable of storing multi-version data with respect to various time-series data, and a database management server for managing the database. The database management server includes search means capable of designating a merge policy defining a policy whether mixing of the multi-version data is acceptable in addition to a search condition of the database. The search means generates a result of merging the multi-version data in a time range contained in the search condition as a data acquisition history based on the designated merge policy, and records the data acquisition history in the database.

### Advantageous Effect of Invention

According to the present invention, the database server that stores multi-version time-series data ensures automatic deletion of the data generated by the old analysis program in a time range included by the search condition so as to automatically minimize the disk space usage of the database server.

### BRIEF DESCRIPTION OF DRAWINGS

FIG. 1 is a schematic view of a database server according to a first embodiment of the present invention.

FIG. 2A represents an example of a correlation among multiple merge policies according to the present invention.

FIG. 2B is an explanatory view illustrating operations of an analysis server, and search means and data registration means of a database management server according to the first embodiment.

FIG. 3A is a view representing an example of time-series data according to the first embodiment.

FIG. 3B is a view representing an example of a data acquisition history according to the first embodiment.

FIG. 4 is a schematic view representing a method of version upgrading an analysis program according to the first embodiment.

FIG. 5 is an explanatory view representing operations of undeletable data find means and deletable data display means of the database management server according to the first embodiment.

FIG. 6A is a flowchart of the undeletable data find program according to the first embodiment.

FIG. 6B is a flowchart of the undeletable data find program according to the first embodiment.

FIG. 7 is a view representing an example of the data acquisition history having a target time range converted into a relative time according to the first embodiment.

FIG. 8 is a view representing an example of the undeletable data according to the first embodiment.

FIG. 9 is a view representing an example of the data acquisition patterns according to the first embodiment.

FIG. 10 is a schematic view representing the multi-version time-series data existing on the database according to the first embodiment.

FIG. 11 is a schematic view representing the multi-version time-series data classified into the undeletable data and the deletable data according to the first embodiment.

FIG. 12 is a view representing an exemplary screen displayed through a deletable data display program according to the first embodiment.

FIG. 13 is a view representing an exemplary screen displayed through the deletable data display program according to the first embodiment.

FIG. 14 is a functional block diagram representing an inner structure of the database management server according to a second embodiment of the present invention.

FIG. 15 is a view representing an exemplary screen displayed through the deletable data display program according to the second embodiment.

FIG. 16 is a functional block diagram representing the inner structure of the database management server according to a third embodiment of the present invention.

FIG. 17 is a view representing an example of a merge policy change plan.

FIG. 18 is a flowchart of a merge policy change plan generation program according to the third embodiment.

FIG. 19 is a view representing an exemplary screen displayed through the merge policy change plan generation program according to the third embodiment.

FIG. 20A is a schematic view representing the processing of the time-series data in stages through multiple analysis programs.

FIG. 20B is a schematic view representing the version upgrading procedure of a generally employed analysis program.

### EMBODIMENTS FOR CARRYING OUT THE INVENTION

A database management server according to the present invention requires declaration of the merge policy as an essential condition of the data acquisition request to the subsequent process, representing whether mixing of multi-version time-series data on the database is acceptable. The database management server returns the time-series data as those of the latest version, the old version, or having the latest version and the old version mixed to the subsequent process in accordance with the given merge policy and the time-series data of the respective versions existing on the database at the subject time point.

The database management server according to the present invention records the data acquisition history which contains the aforementioned merge policy. Based on the data acquisition history, the deletable data are located among the time-series data on the database generated through the old analysis program. The database management server presents a database manager with those deletable data, or automatically deletes those time-series data from the database.

Based on the data acquisition history, the database management server according to the present invention calculates the merge policy change plan designated by the subsequent process, and data amount which can be reduced upon change in the merge policy. The database management server presents the developer of the subsequent process with those merge policy change plans, or automatically applies those policy change plans.

The database management server according to the present invention allows the database server that stores the multi-version time-series data to automatically delete the time-series data generated by the old analysis program from the database so as to automatically minimize the disk space usage of the database server. In other words, the database management server according to the present invention does not allow acquisition of the time-series data in the database generated by the old analysis program through designation of the subsequent process of the analysis server with the version number. If the database management server allows the subsequent process to acquire the data designated with the version number, the subsequent process may have a risk of using the time-series data of old version continuously.

If the data are not automatically deleted, the database management server according to the present invention is allowed to present the database manager and the developer of the subsequent process with the reason for deletion of the time-series data generated by the old analysis program and preference for changing the merge policy of the subsequent process. Accordingly, the user such as the database manager is capable of reducing the working hours for determining the data to be actually deleted from the database by using the presented information. The embodiments according to the present invention will be described in detail referring to the drawings.

### First Embodiment

The database server according to a first embodiment of the present invention will be described referring to the drawing.

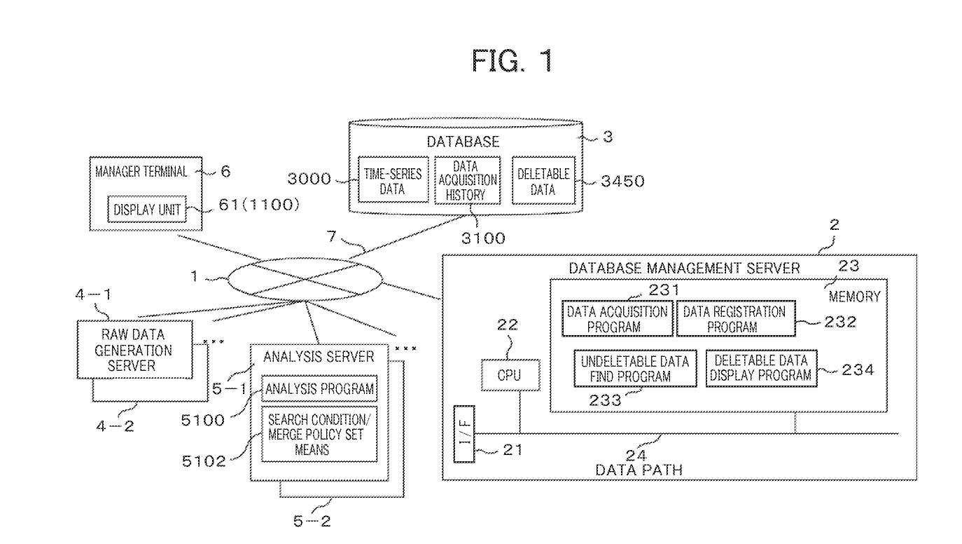

FIG. 1 schematically illustrates the database server according to the first embodiment. The inner structure of the database management server is represented by the functional block diagram.

The database server according to the present invention includes an analysis server and the database management server, and executes an analysis process of the database through the analysis server in response to reception of a request for search and update of the database from the client so that the results are returned to the application. That is, the database server is composed of a database management server 2, a database 3, a raw data generation server 4, an analysis server 5, and a manager terminal 6. The aforementioned devices are connected to a network 1 via a physical communication channel 7.

The database management server 2 is configured to manage data input and output operations with respect to the database 3 to be described later. The database management server 2 has a function of finding deletable data from those generated by the old analysis program.

The database management server 2 sends and receives packets via an interface (I/F) 21. The respective programs of the database management server 2 are stored in a memory 23, and are read and executed by a CPU 22 via a data path 24 in operation.

The memory 23 stores a data acquisition program 231, a data registration program 232, an undeletable data find program 233 and a deletable data display program 234. Those programs are executed by the CPU 22 so as to allow a computer (database management server 2, manager terminal 6 and analysis server 5) to function as search means or the data acquisition means (231), the data registration means (232), the undeletable data find means (233), and the deletable data display means (234).

The database 3 stores time-series data 3000 and an acquisition request history to those time-series data (hereinafter referred to as data acquisition history) 3100. The database 3 is configured to temporarily retain deletable data 3450.

The raw data generation server 4 generates the time-series data (raw data) to be analyzed, and registers the data in the database 3. Normally, multiple raw data generation servers 4 (4-1, 4-2,) are provided. For example, the raw data generation server includes a Web application server on which the agent software for measuring the server performance information (usage rate of CPU) and a compact device for recording the value measured by the sensor (temperature and the like). When registering the data in the database 3, the raw data generation server 4 does not have to designate the version number. However, it is possible to designate the version number likewise the analysis server 5. In such a case, the data of old version will be deleted even if such data are raw.

Multiple analysis servers 5 (5-1, 5-2,) are provided, on which one or more analysis programs 5100 are executed. The analysis program (analysis means) 5100 acquires the time-series data (data registered by the raw data generation server 4 or data registered by the analysis server 5), and subjects those data to a certain process. The process includes creation of the Web page for displaying the monitored results on the Web browser. The analysis program is also allowed to register the analytical results in the database 3 as the time-series data of type (different name) other than that of the acquired time-series data. The analysis program has to designate the version number thereof when registering the data in the database 3. The analysis server 5 also has means 5102 for setting the search conditions and merge policies as a part of the analysis program function.

The manager terminal 6 includes a display unit 61 with GUI function, and is operated by a database manager and a developer (user) of the subsequent process of the analysis program for the use of the database management server 2 via a display screen (1100). The user confirms the output of the program which runs on the database management server 2 through the client software (Web browser and the like) operated on the manager terminal 6. The user appropriately sets search conditions for the analysis server 5 and parameters on the merge policies through the manager terminal 6. The analysis server 5 operates the analysis program based on the thus set search conditions and merge policies.

Multiple database management servers 2 and multiple databases 3 may be provided so long as the undeletable data find means 233 is allowed to access all the time-series data 3000 and the data acquisition histories 3100 concerning the specific target data. For that reason, the present invention is applicable to the distributed database.

Then the database management server 2 will be described in detail.

The search means or the data acquisition means (hereinafter referred to as search means) 231 is the program that returns the time-series data on the database 3 in response to the data acquisition request from the analysis means that runs on the analysis server 5. The analysis means is required to contain the policy (hereinafter referred to as merge policy) whether or not mixing of the multi-version data is acceptable in the data acquisition request. Upon reception of the data acquisition request which does not contain the merge policy, the search means 231 rejects reception of the data acquisition request, or executes the process of the data acquisition request using the default merge policy. The search means then records the history of the data acquisition request that contains the merge policy in the database 3.

The merge policy includes, for example, “prioritizing any one of the data of the latest version and the data of version existing for the longest term in the time range contained in the search condition”, “whether or not the mixing of the multi-version data is acceptable”, “whether or not the search is cancelled when the multi-version data are merged”, “whether or not the data of the same version as that of the data acquired in the past are prioritized”, and the like.

Specific examples of the merge policies 1 to 6 according to the embodiment will be described hereinafter.

(1) If the multi-version data are mixed in the time range contained in the search condition, the data of the latest version in the range are prioritized. Results derived from merging the data of different versions are acquired.
(2) If the multi-version data are mixed in the time range contained in the search condition, the data of version existing for the longest term in the range are prioritized. Results derived from merging the data of different versions are acquired.
(3) If the multi-version data are mixed in the time range contained in the search condition, only the data of the latest version in the range are acquired.
(4) If the multi-version data are mixed in the time range contained in the search condition, only the data of version existing for the longest term are acquired.
(5) If the multi-version data are mixed in the time range contained in the search condition, and the whole range cannot be covered by the data of version existing for the longest term in the range, the search is cancelled.
(6) If the multi-version data are mixed in the time range contained in the search condition, the data of the same version as that of the data acquired by the means in the past are prioritized, and results derived from merging the data of different versions are acquired.

The merge policies 1, 2 and 6 are examples of merging of multi-version data. Conversely, the merge policies 3, 4 and 5 are examples for not merging. The merge policies 1, 3 and 6 are examples of prioritizing the data of the latest version. Especially, the merge policy 5 is an example for not continuing the search upon the merge of the multi-version data. The merge policy 6 is an example for prioritizing the data of the same version as that of the data acquired in the past.

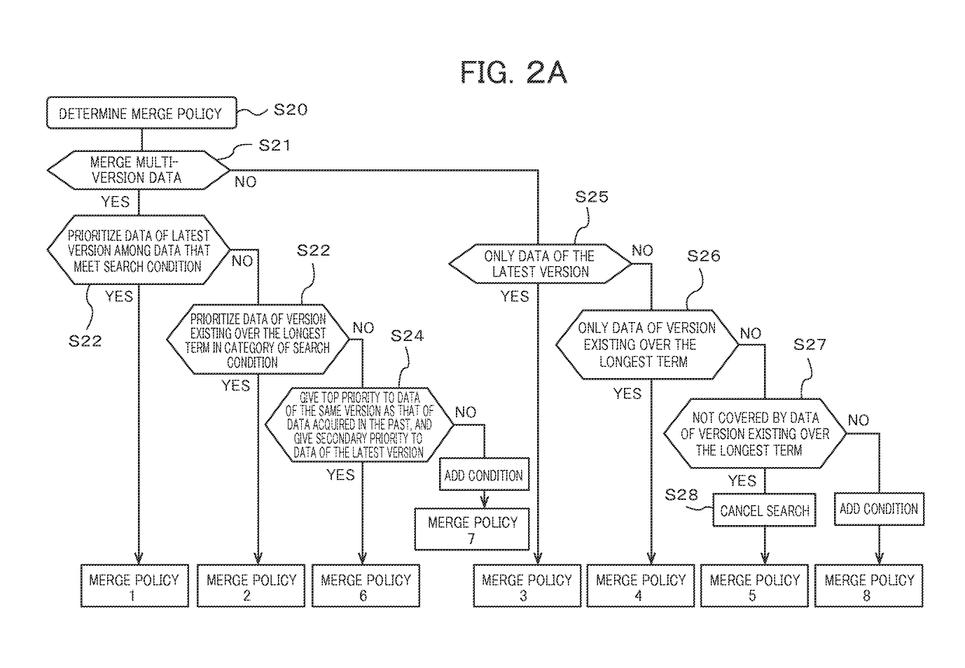

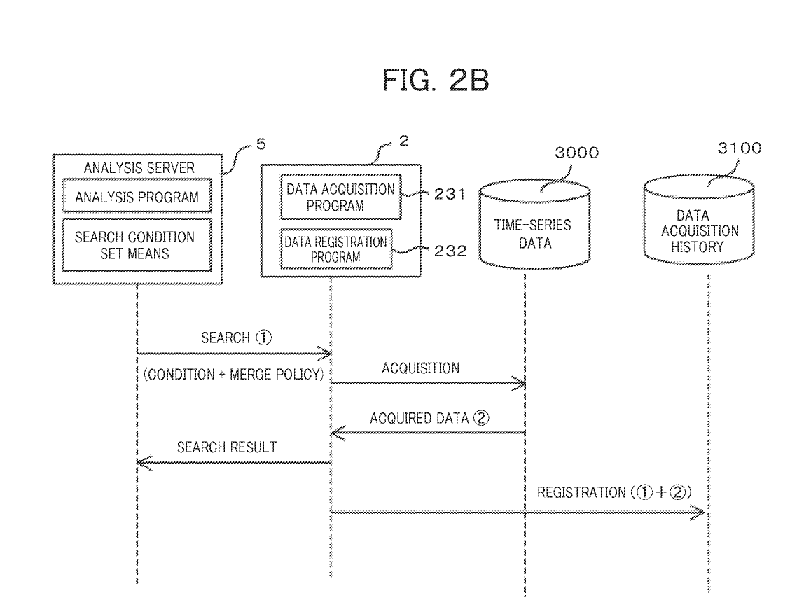

FIG. 2A represents an example of the correlation among the merge policies as described above. The analysis means 5100 is required to make sure to determine the merge policy (S20). The multiple merge policies may be classified into two groups depending on “whether or not the multi-version data are merged” (S21). In the case where the data are merged (YES in S21), the merge policy 1 is determined (YES in S22) to prioritize the data of the latest version in the time range contained in the search condition. The merge policy 2 represents that the data of version existing for the longest term in the range are prioritized (YES in S23). The merge policy 6 represents that the data of the same version as that of the data acquired in the past (YES in S24) are prioritized. Otherwise (NO in S24), the merge policy 7 is determined to set the specific condition.

Meanwhile, if the multi-version data are not merged (NO in S21), the merge policy 3 is determined to prioritize the data of the latest version (YES in S25). The merge policy 4 represents that the data of version existing for the longest term in the range (YES in S26) are prioritized. The merge policy 5 represents cancellation of the search (S28) by prioritizing the data of the same version as that of the data acquired in the past (YES in S27). Otherwise (NO in S27), the merge policy 8 is determined to set the specific condition.

The above description presents only examples of the merge policies especially considered as practical among possible merge policies. In this embodiment, the analysis server 5 allows the search means 231 to use the values 1 to 6 to designate the merge policies, or set additional conditions of 7 and 8. However, the method of expressing the merge policy is not limited to those described above, which may be extended in the range so as not to deviate from the scope of the present invention. For example, the merge policy may be the set of multiple Boolean values instead of the single integer value. Alternatively, the merge policy may have the parameter. For example, the search means 231 may accept the merge policy to “prioritize data for covering n % of the time range contained in the search condition over the data of the latest version (n=60)”.

The search means 231 may be configured to apply the fixed merge policy in accordance with the transmission source of the data acquisition request. For example, the database manager is allowed to enter the fixed merge policy into the set file on the database management server with the request source program name, the IP address of the request source and the port number as the key. The search means 231 may be configured to make reference to the set file for each reception of the data acquisition request to determine the merge policy. This method requires the developer of the subsequent process to be authorized to edit the set file on the database management server.

The data registration means 232 is a program for registering the time-series data to the database 3 in accordance with the data registration request from the software that runs on the raw data generation server 4 or the analysis program operated in the analysis server 5. It is indispensable for the data registration request from the analysis program to contain the version number of the corresponding analysis program.

The data registration means 232 may be configured to apply the fixed version number in accordance with the data transmission source. For example, the database manager enters the fixed version number into the set file on the database management server through the transmission source program name, the IP address of the transmission source and the port number as the key. The data registration means 232 may be configured to determine the version number by making reference to the set file for each reception of the data registration request. However, this method requires the developer of the subsequent process to be authorized to edit the set file on the database management server.

FIG. 2B is an explanatory view representing operations of the analysis server 5, and the search means 231 and the data registration means 232 of the database management server 2. The analysis server 5 activates the search means 231 of the database management server 2 to search the time-series data 3000 of the database 3 based on the given search conditions and the merge policy. The search results are stored in the data acquisition history 3100 of the database 3 through the data registration means 232.

The database 3 will be described in detail. The database 3 according to the embodiment stores data in a table form. The embodiment is not limited to those data in the table form.

The time-series data 3000 include those generated by the raw data generation server 4 and registered in the database 3 (raw data), and those generated by the analysis server 5 (results derived from analyzing the raw data, or results derived from further analyzing a certain analytical result).

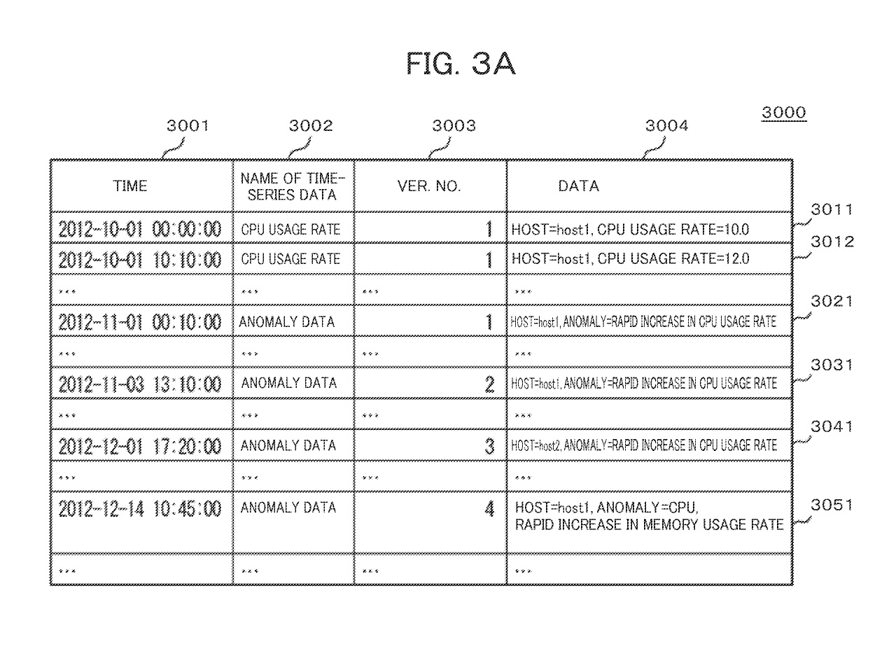

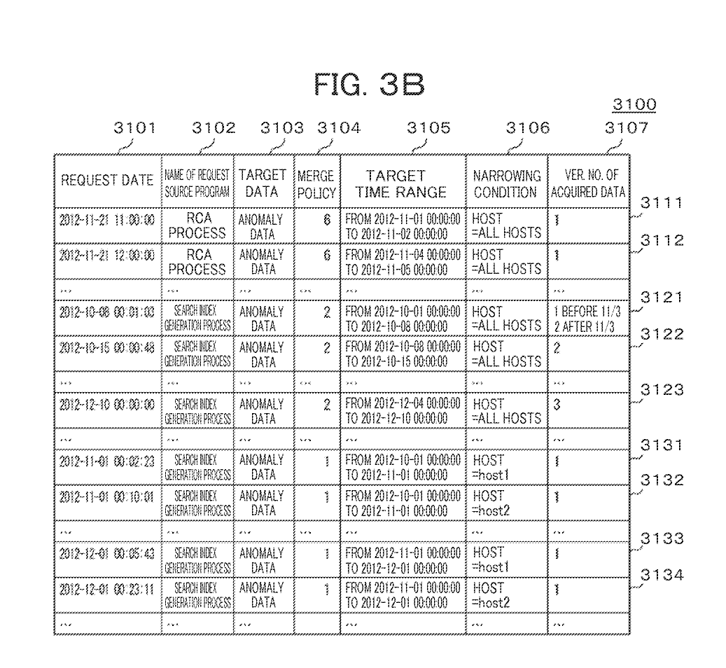

FIG. 3A shows an example of the time-series data 3000. A column 3001 of the time-series data 3000 represents the time associated with the time-series data. It is possible to use the time at which the time-series data are generated, or the head of the time range indicated by the time-series data. A column 3002 represents the name of the time-series data. Referring to the example, the “CPU usage rate” is the name registered by the raw data generation server 4, and “anomaly data” represents the name of analytical results registered by the analysis program “anomaly detection process” which is operated by the analysis server 5. A column 3003 represents the version number of the time-series data. The blank space or the fixed value is entered in the column 3003 of the data (rows 3011 and 3012) registered by the raw data generation server 4. Meanwhile, the column 3003 for the processed data (rows 3021 to 3051) registered by the analysis program stores version numbers of the analysis program which has generated the processed data. Normally, the version number in the column 3003 is the one of the analysis program which has generated the time-series data. However, the version number of the analysis program does not have to necessarily correspond to that of the time-series data one-to-one. A column 3004 represents data other than the time, which are contained in the time-series data. In this example, the data other than the time are expressed as key and value in pairs. For example, the row 3011 represents that the CPU usage rate acquired from the server with the host name of host1 is 10.0% on Oct. 1, 2012, at 00:00:00. The rows 3021 and 3031 with the time-series data name of “anomaly data” represent rapid increase in the CPU usage rate.

FIG. 3B is an example of the data acquisition history 3100. The data acquisition history 3100 is generated by the search means 231 upon reception of the data acquisition request from the analysis server 5. A column 3101 represents the time at which the data acquisition request is accepted. A column 3102 represents the name for uniquely identify the program that transmits the data acquisition request. Instead of using the name, it is possible to use the other string (IP address of the transmission source of the data acquisition request and the like) which allows unique identification of the program in the system. A column 3103 represents the name of the time-series data as the target of the data acquisition request. A column 3104 represents the number of the merge policy designated by the data acquisition request. A column 3105 represents the time range designated by the data acquisition request. The starting time or the end time of the range does not have to be designated. A column 3106 represents the search condition except the time, which is designated by the data acquisition request. In other words, the column 3104 represents the merge policy, and the columns 3105, 3106 represent the data search conditions. A column 3107 represents the version number of the time-series data returned as the result of the data acquisition request. If the multi-version data are merged in accordance with the merge policy, the version number for each term is recorded as indicated by a row 3121.

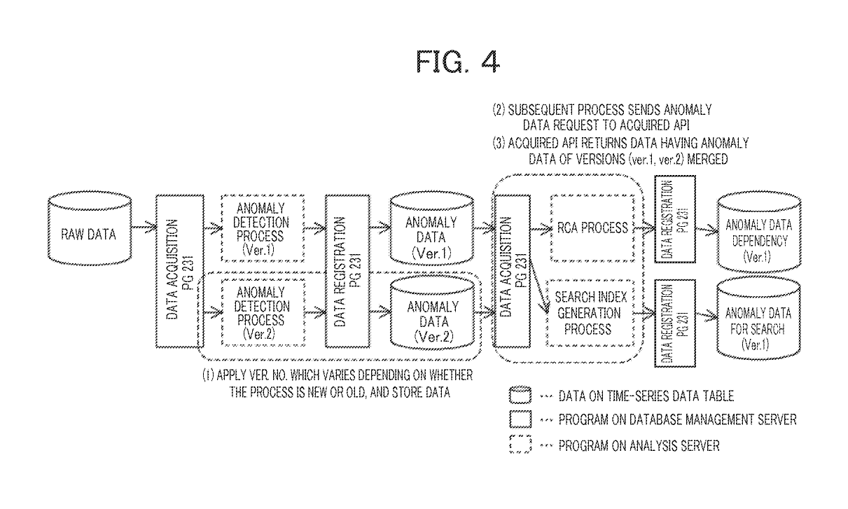

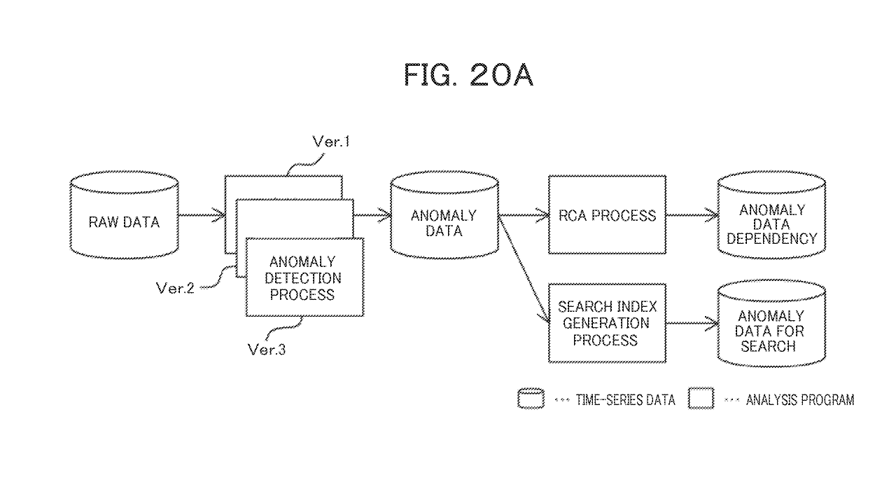

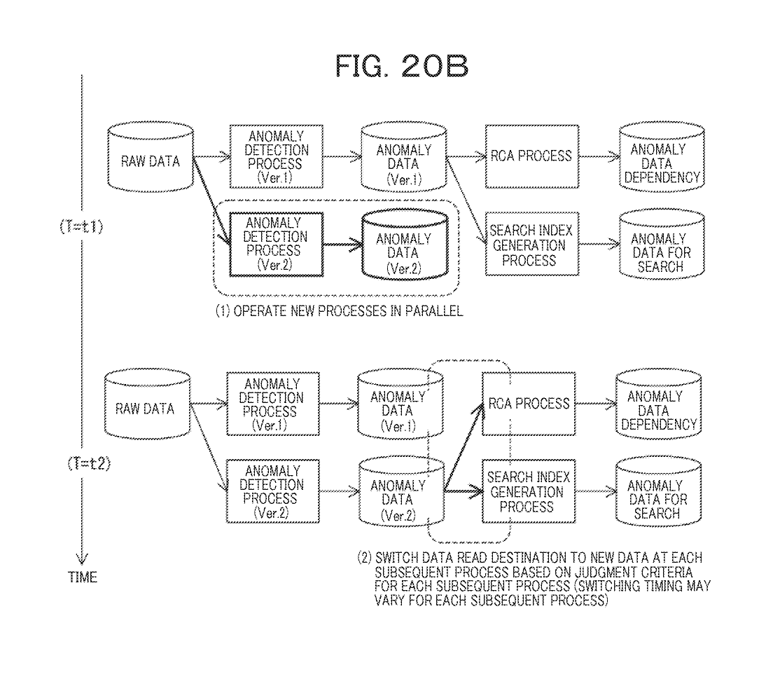

FIG. 4 is a schematic view illustrating a method of version upgrading the analysis program 5100 according to the first embodiment. In this example, two analysis programs (“RCA process”, “search index generation process”) exist as the subsequent process of the analysis program “anomaly detection process” 5100 likewise the example shown in FIG. 20B. Unlike the one shown in FIG. 20B, the search means 231 performs switching of the data read destination (switching from ver. 1 to ver. 2 of the anomaly data).

Referring back to FIG. 1, the undeletable data find means 233 of the database management server 2 is the program for finding the undeletable time-series data based on the data in the database 3. This program is activated by the database manager or the developer of the analysis program via the manager terminal 6, or automatically activated by a job scheduler available on Linux® such as cron. This program passes the generated data to the deletable data display program.

The deletable data display means 234 of the database management server 2 presents the database manager or the developer (user) of the analysis program with the information on the deletable time-series data based on the data generated by the undeletable data find means 233. Alternatively, the time-series data judged as deletable by this program are automatically deleted.

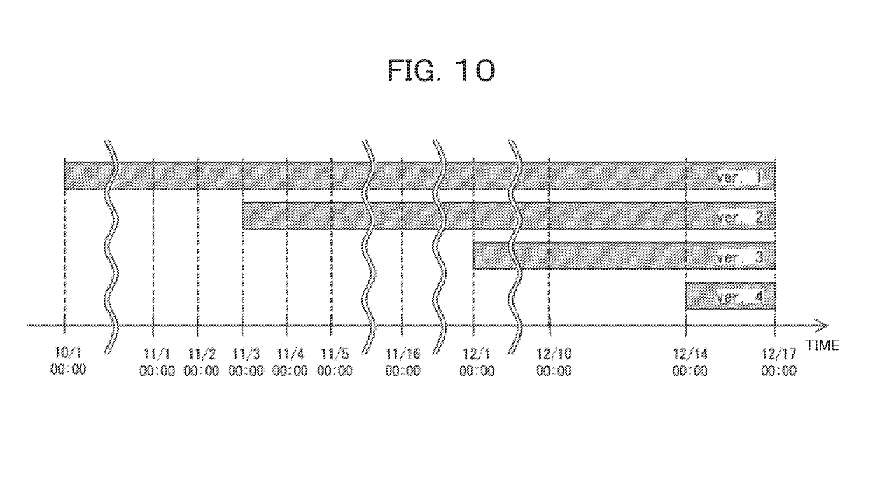

The following explanation will be made on the assumption that the anomaly data of multiple versions concerning the analysis program 5100 exist on the database. FIG. 10 schematically shows the time-series data of four versions (Ver. 1, Ver. 2, Ver. 3, Ver. 4) on the database. Referring to the example shown in FIG. 10 with respect to the analysis program 5100, the Ver. 1 exists for the longest term, and the Ver. 4 is the latest.

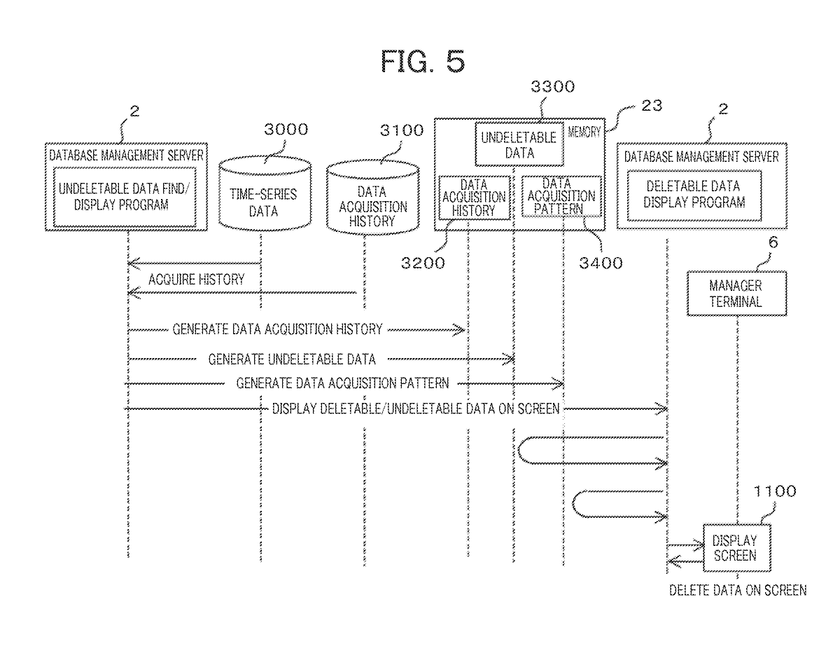

The following explanation will describe the procedure from finding the deletable data among anomaly data of four versions to presenting the database managers with the located deletable data. The undeletable data find means 233 and the deletable data display means 234 will be described in detail referring to FIG. 5 as follows.

FIG. 5 is an explanatory view of operations of the undeletable data find means 233 and the deletable data display means 234 of the database management server 2.

The undeletable data find means 233 generates data acquisition history (relative time) 3200 derived from converting the target time range of the data acquisition history 3100 into the relative time based on the time-series data 3000 of the database 3, and finds the undeletable time-series data so as to generate two kinds of information (undeletable data 3300 and data acquisition pattern 3400) concerning the undeletable time-series data.

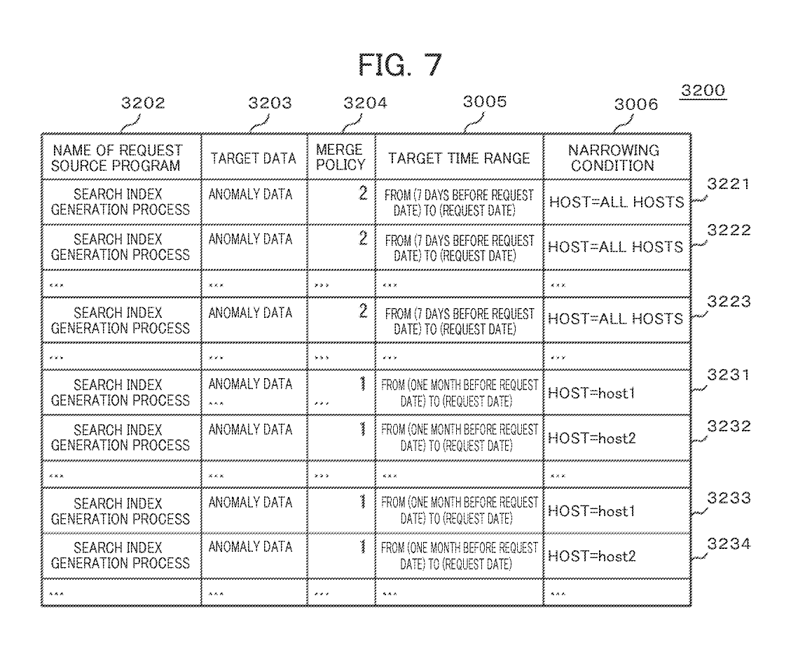

The data acquisition history 320 (see FIG. 7) is derived from converting a target time range 3205 of the data acquisition history 3100 shown in FIG. 3B into a relative time range 3205.

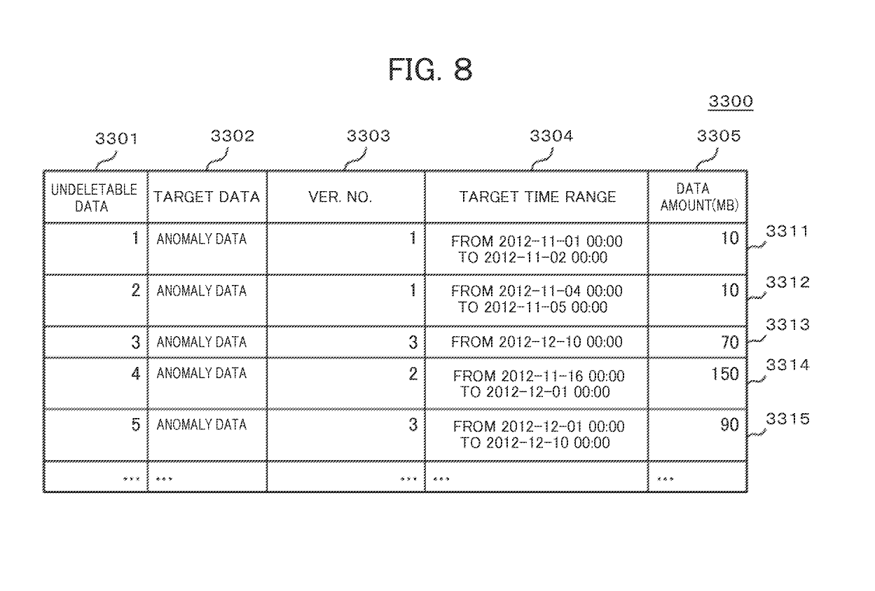

The undeletable data 3300 (see FIG. 8) include the name of the time-series data, the version number, the target time range and the like which should not be deleted. The data are essential for operating the deletable data display means 234.

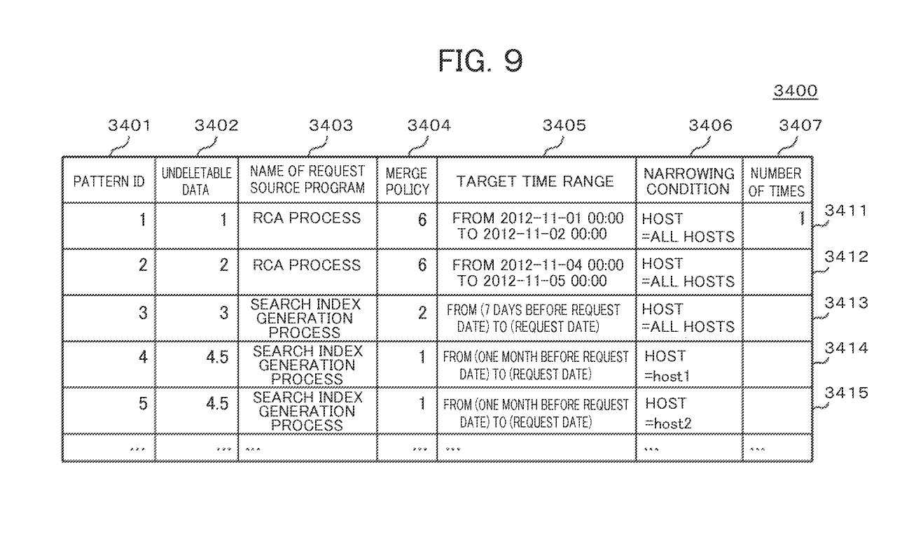

A data acquisition pattern 3400 (see FIG. 9) represents contents of the data acquired in the past as the reason for not deleting the time-series data represented by the undeletable data 3300. The data are not essential for operating the deletable data display means 234. However, generation of the data allows the deletable data display means 234 to provide the effect of presenting the system manager and the developer of the analysis program with the specific reason for inability to delete apart of the time-series data. The undeletable data find means 233 passes those undeletable time-series data to the deletable data display means 234.

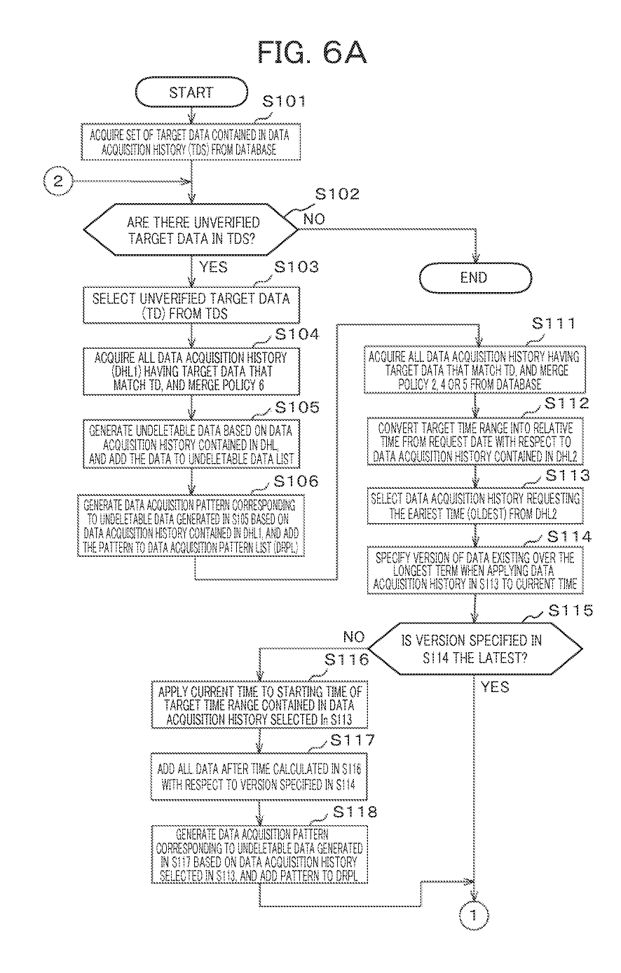

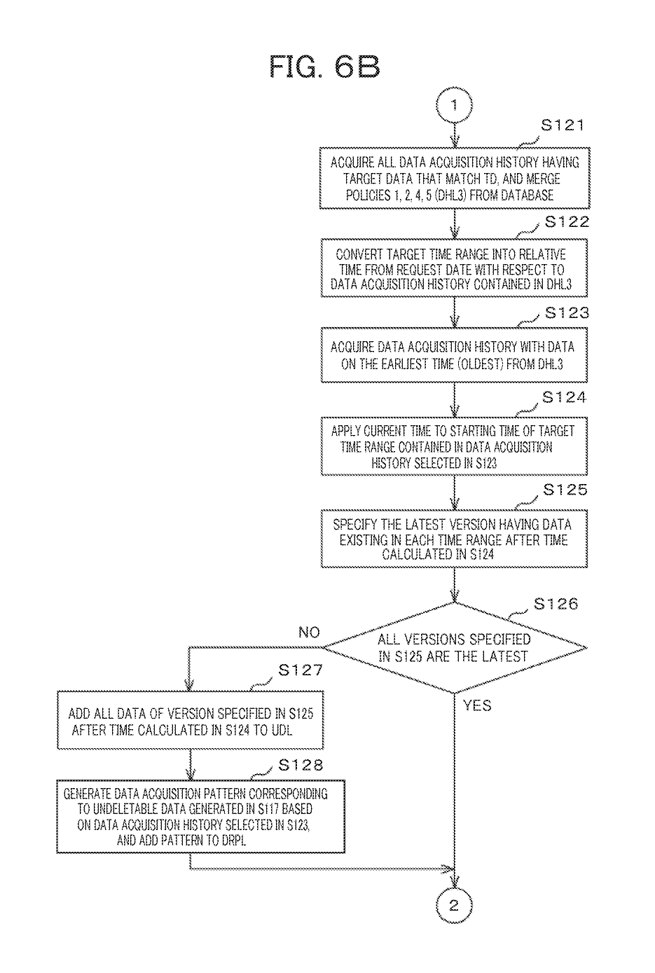

FIGS. 6A and 6B are flowcharts of the process performed by the undeletable data find means 233 for finding the undeletable time-series data (undeletable data 3300, data acquisition pattern 3400) from the data acquisition history 3100.

Firstly the undeletable data find means 233 acquires the set of target data 3103 contained in the data acquisition history 3100 (S101). The set of the target data will be referred to as TDS. According to the example of the data acquisition history 3100 shown in FIG. 3B, the TDS only contains the “anomaly data”. Thereafter, the respective target data (TD) contained in the TDS are subjected to process steps S104 to S128 (S102 and S103).

The undeletable data find means 233 acquires all the data acquisition histories 3100 having the target data that match the TD and the merge policy 6 from the database 3 (S104). The resultant data acquisition history contains the merge policy 6 to “prioritize the same version as that of the data acquired in the past”. In the following description, the aforementioned data acquisition history list will be referred to as DHL1. According to the example of the data acquisition history 3100 shown in FIG. 3B, the DHL1 contains the data acquisition histories in the rows 3111 and 3112.

The undeletable data find means 233 generates the undeletable data 3300 based on the data acquisition history contained in the DHL1 The generated data are added to the list (hereinafter referred to as UDL) of the undeletable data 3300 on the memory (S105).

FIG. 8 shows an example of the undeletable data 3300. A column 3301 represents an identifier uniquely allocated to the respective undeletable data by the undeletable data find means 233. A column 3302 represents the name of the time-series data which should not be deleted. A column 3303 represents the version number of the time-series data which should not be deleted. A column 3304 represents a target time range of the time-series data which should not be deleted. A column 3305 represents each amount of the time-series data in the columns 3302 to 3304.

Referring to S105 of FIG. 6A, the undeletable data find means 233 generates data in the columns 3302, 3303 and 3304 of the undeletable data 3300 based on the data in the columns 3103, 3105 and 3107 of the data acquisition history 3100. The undeletable data ID in the column 3301 is newly allocated by the undeletable data find means 233. The data amount in the column 3305 is newly calculated through the search of the time-series data 3000 performed by the undeletable data find means 233. The respective data in the columns 3302, 3303 and 3304 have to be uniquely grouped, respectively. If the data acquisition history 3100 has multiple rows 3111, the single row 3111 of the undeletable data 3300 is only generated.

The undeletable data find means 233 further generates the data acquisition pattern 3400 corresponding to the undeletable data generated in S105 based on the data acquisition history contained in the DHL1. Then the generated data are added to the list (DRPL) of the data acquisition pattern on the memory (S106).

FIG. 9 shows an example of the data acquisition pattern 3400. A column 3401 represents the identifier uniquely allocated to the respective data acquisition patterns by the undeletable data find means 233. A column 3402 represents the identifier of the undeletable data corresponding to the data acquisition pattern. For example, a row 3414 of the data acquisition pattern 3400 indicates that the data acquisition request shown in the row has been made in the past, and accordingly, the time-series data in the target time range in the column 3304 from the rows 3314 to 3315 of the undeletable data 3300 shown in FIG. 8 cannot be deleted. A column 3403 represents the name of the program which has executed the data acquisition pattern in the past. The data in the columns 3404 to 3406 represent the merge policies of the past data acquisition requests represented by the data acquisition pattern, the target time range and the narrowing condition, respectively. A column 3407 represents the number of times of the past data acquisition request indicated by the data acquisition pattern.

The undeletable data find means 233 generates data in columns 3403 to 3406 of the data acquisition pattern 3400 based on the data in the columns 3102 to 3106 of the data acquisition history 3100. The pattern ID in the column 3401 is newly allocated by the undeletable data find means 233. The undeletable data ID in the column 3402 stores the ID of the undeletable data generated by the undeletable data find means 233 in S105. If multiple undeletable data are generated in S105, the multiple undeletable data IDs are stored accordingly. The number of times in a column 3407 stores the number of the data acquisition histories with respect to the time-series data represented by the undeletable data generated in S105.

The undeletable data find means 233 acquires all data acquisition histories having the target data that match the TD and merge policy 2, 4 or 5 (S111). The data acquisition history contains the merge policy to “prioritize data of version existing for the longest term over data of the latest version”. The data acquisition history list will be hereinafter referred to as DHL2. According to the example of the data acquisition history 3100 shown in FIG. 3B, the data acquisition histories in the rows 3121 to 3123 are contained in the DHL2.

Then the undeletable data find means 233 generates data acquisition history (relative time) 3200 derived from converting the target time range of the data acquisition history 3100 into the relative time (S112).

Referring to the example of the data acquisition history 3100 contained in the DHL2, the data acquisition histories in the rows 3121 to 3123 are converted into the data in the rows 3221 to 3223 of the data acquisition history 3200 shown in FIG. 7.

Referring to FIG. 7, columns 3202 to 3204 and 3206 of the data acquisition history 3200 are equivalent to those in the columns 3102 to 3104 and 3106 of the data acquisition history 3100 shown in FIG. 3B. Data of the column 3205 are derived from converting the data in the target time range in the column 3105 shown in FIG. 3B into the relative time from the request date in the column 3101. Upon the conversion, the trend of frequently performed data acquisition becomes obscure in consideration of the detailed difference in the request date. For this, the undeletable data find means 233 may be configured to have the time in the column 3101 in minutes or seconds rounded down or up. In this embodiment, the time in the column 3101 in minutes is rounded down for comparison between the columns 3101 and 3105 so as to convert the target time data in the column 3105 into the relative time. The undeletable data find means 233 may be configured to abstract the target time range as well. For example, the search for the time-series data before 30 days, and the search for the time-series data before 31 days may be subjected to abstraction, that is, “search for the time-series data before 1 month”.

The undeletable data find means 233 selects the data acquisition history which requests the data at the earliest time (the oldest) from the data acquisition history 3200 contained in the DHL2 (S113).

In the case where the target time range includes two data acquisition histories, that is, “from (7 days before request date) to (request date)” and “from (14 days before request date) to (7 days before request date)”, the undeletable data find means 233 selects the latter history. Referring to the example in the rows 3121 to 3123 of the data acquisition history 3100 shown in FIG. 3B, those values are converted into the same contents (rows 3221 to 3223 of the data acquisition history 3200 shown in FIG. 7) through abstraction. Therefore, the undeletable data find means 233 selects any one of data in the rows 3221 to 3223 of the data acquisition history 3200 shown in FIG. 7. In the following description, it is assumed that the row 3221 is selected.

Then the undeletable data find means 233 specifies the version existing for the longest term in the case where the data acquisition history selected in S113 is applied to the current time (S114).

Assuming that the current time is 12/17 00:00, application of the current time to the target time range shown in the row 3221 of the data acquisition history 3200 provides the result “from 12/10 00:00 to 12/17 00:00”.

Referring to an example shown in FIG. 10, the number of the version existing for the longest term in the time range is 3. If there are multiple versions existing for the longest term, the latest one among those versions is selected.

If the version specified in S114 is the latest (version number 4 in the example shown in FIG. 10), there are no data of old version which should not be deleted. Therefore, the process proceeds to the process step subsequent to S121 (S115). Otherwise, the undeletable data are generated in the process steps S116 and S117.

The undeletable data find means 233 applies the current time to the starting time of the target range contained in the data acquisition history selected in S113 (S116). Then all the data at the time calculated in S116 onward with respect to the version specified in S114 are added to the UDL (S117). For example, from the row 3221 shown in FIG. 7, the undeletable data in the row 3313 shown in FIG. 8 are generated. In the same way as in S105, the undeletable data find means 233 calculates the amount of the subject undeletable data.

The undeletable data find means 233 generates the data acquisition pattern corresponding to the undeletable data generated in S117 based on the data acquisition history selected in S113. The generated pattern is added to the DRPL (S118). For example, the data acquisition pattern in the row 3413 of the data acquisition pattern 3400 shown in FIG. 9 is generated from the undeletable data in the row 3221.

Furthermore, the undeletable data find means 233 acquires all the data acquisition histories having the target data that match TD and the merge policy 1, 2, 4 or 5 from the database (S121). Those data acquisition histories include the merge policy which has “possibility of acquiring the data of past version”. In the following description, the list of the data acquisition history will be referred to as DHL3. Referring to the example shown in FIG. 3B, the data acquisition histories in the rows 3121 to 3134 are contained in the DHL3.

The undeletable data find means 233 converts the target time range into the relative time from the request date with respect to the data acquisition history contained in the DHL3 (S122). This process is similar to the process step S112. Referring to the example shown in FIG. 3B, the data acquisition histories in the rows 3121 to 3134 are converted into those in the rows 3221 to 3234, respectively as shown in FIG. 7.

The undeletable data find means 233 selects the data acquisition history that requests the data at the earliest time (in other words, the oldest) from the data acquisition history contained in the DHL3 (S123). If there are multiple data request histories under the same narrowing condition, all the data are selected. This process is similar to the process step S113. The data acquisition history requesting the data at the earliest (the oldest) time among those in the rows 3221 to 3234 as shown in FIG. 7 correspond to those in the rows 3231 to 3234 representing the target term up to “before one month”. In the following description, it is assumed that two data in the rows 3231 and 3232 are selected from those acquisition histories.

The undeletable data find means 233 applies the current time to the starting time of the target time range contained in the data acquisition history selected in S123 (S124). Then the undeletable data find means 233 specifies the latest version of the existing data with respect to each time range at the time calculated in S124 onward (S125). Referring to the example shown in FIG. 10, the number of the latest version in the time range from 11/16 00:00 to 12/1 00:00 of the target term up to “before one month” is 2. The number of the latest version in the time range from 12/1 00:00 to 12/14 00:00 is 3. The number of the latest version in the time range thereafter is 4.

If all the versions specified in S125 are the latest (in the example shown in FIG. 10, the version number is 4), there are no data of the old version which should not be deleted. Accordingly, the process proceeds to step S121 onward (S126). Otherwise, the undeletable data are generated in the process steps S127 and S128.

The undeletable find means 233 adds all the data at the time calculated in S124 onward to the UDL with respect to versions 2 to 4 (S127). For example, the undeletable data in the rows 3314 and 3315 shown in FIG. 8 are generated from those in the rows 3231 and 3232 shown in FIG. 7 with respect to the versions 2 and 3. The undeletable data find means 233 calculates the amount of the undeletable data using the same method as in step S105.

The undeletable data find means 233 generates the data acquisition pattern 3400 corresponding to the undeletable data generated in S127 based on the data acquisition history selected in S123, and adds the generated pattern to the DRPL (S128). For example, the data acquisition patterns in the rows 3414 and 3415 shown in FIG. 9 are generated from the undeletable data in the rows 3231 and 3232 shown in FIG. 7.

The process executed by the undeletable data find means 233 for finding the undeletable time-series data 3300 have been summarized. The undeletable data find means 233 passes the aforementioned UDL and DRPL to the deletable data display means 234.

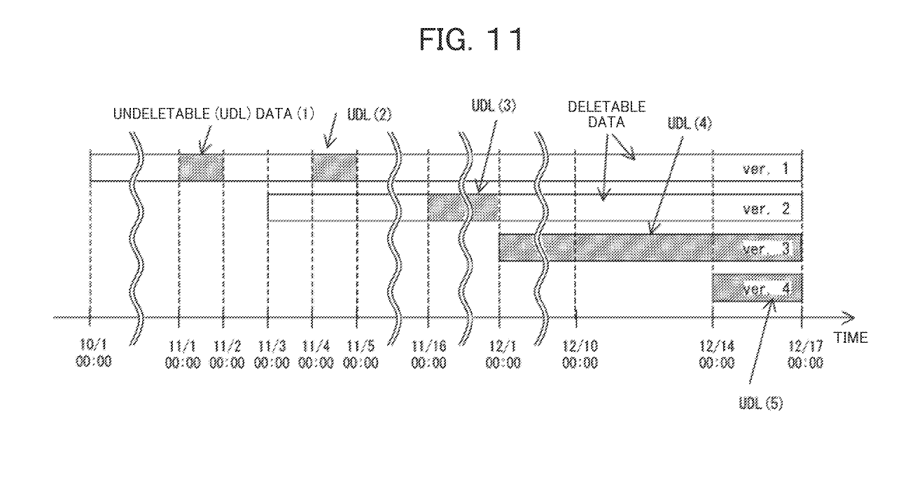

FIG. 11 is a schematic view representing a relationship between the undeletable data 3300 and the deletable data 3400 in the case where the multi-version data exist on the database. For example, if the multi-version time-series data shown in FIG. 10 and the data acquisition history shown in FIG. 3B exist, the undeletable data find means 233 outputs hatched regions of the respective versions as shown in FIG. 11 as the UDL. The undeletable data UDL (1) to (5) correspond to the undeletable data (1) to (5) shown in FIG. 8. Referring to FIG. 11, the non-hatched region denotes the deletable data (hereinafter referred to as deletable data 3450). Referring to FIG. 11, existence of the undeletable data in the new and old versions implies that it is unclear whether the program is appropriately operated when the program version is changed to the new one. For that reason, the data corresponding to the old version are retained in accordance with the merge policy.

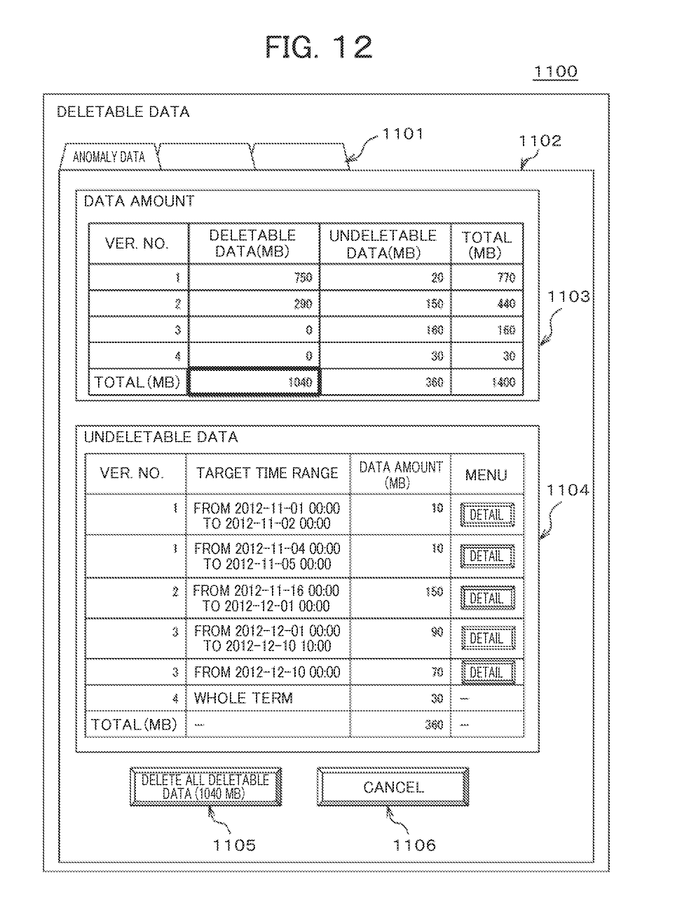

FIG. 12 illustrates an example of the screen display 1100 through the deletable data display means according to the first embodiment. A reference number 1101 of the screen display 1100 denotes a tab representing the name of the deletable time-series data. The number of tabs to be displayed corresponds to the number of types of the deletable time-series data. A reference number 1102 denotes the region for representing the deletable time-series data in detail. When the user selects the tab 1101, the deletable time-series data among those of the selected type are displayed in the frame of the region 1102. A reference number 1103 denotes the region indicating amounts of the deletable data 3450 and the undeletable data 3400 for the respective multiple versions. The undeletable data are generated based on the UDL. The deletable data 3450 are generated by dividing the total amount of those of the respective versions by the amount of the undeletable data 3400. The total amount of the data of the respective versions may be calculated by the deletable data display means 234 upon display on the screen, or may be preliminarily calculated through another program. A reference number 1104 denotes the region representing the undeletable data 3400 in detail. In this region, the UDL contents are directly displayed. A reference number 1105 is a button for collectively deleting all the deletable data 3450. When the user depresses this button, the deletable data display means deletes all the data except the undeletable data 3400 displayed in the region 1104. A reference number 1106 is a button for closing the screen without performing the actual deletion.

The deletable data display means 234 is allowed to present the user with the reason for inability to delete the respective undeletable data 3400. For example, as the method for presenting such reason, it may be displayed in response to depression of “Detail” button in the region 1104 as shown in FIG. 12.

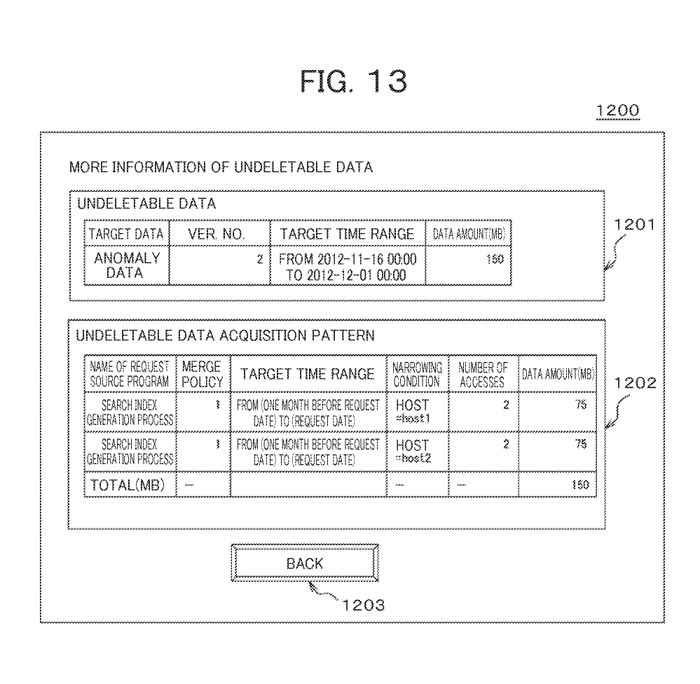

FIG. 13 is a view illustrating an example of the undeletable data 3400 displayed in detail by the deletable data display means according to the first embodiment. A reference number 1201 denotes the region that displays the information of the undeletable data 3400 in detail. A reference number 1202 denotes the region that displays the past data acquisition pattern indicating the reason for inability to delete the data. The DRPL contents may be directly displayed in this region. A reference number 1203 denotes the “Back” button.

Referring to the example shown in FIG. 12, the deletable data display means displays the undeletable data 3400 in the region 1104 in detail in order to allow the menu (“Detail” button) to easily display the data acquisition pattern (FIG. 13) corresponding to the undeletable data. However, details of the deletable data display means may be configured to display the deletable data 3450 in this region.

As described above, the deletable data display means 234 presents the database managers with the deltabale data contained in the multi-version time-series data on the display screen. The deletable data display means 234 is also allowed to present the database managers with the reason for ability to delete the data generated by the old analysis program on the display screen. According to the embodiment, the database server that stores multi-version time-series data is configured to display the time-series data of respective versions on the display screen in two groups of the undeletable data and the deletable data, respectively. The use of such information allows determination of the data to be deleted by the judgment of the user. The user is allowed to minimize the amount of data generated by the old analysis program on the database server.

This allows the database manager to minimize the amount of the multi-version time-series data generated by the old analysis program on the database server upon review (version upgrading) of the analysis process. It is also possible for the database managers to reduce the actual working hours for determining the data to be deleted.

The undeletable data find means 233 and the deletable data display means 234 as described above may be automatically activated. Those programs may be designed to automatically execute the process up to deletion of the deletable data 3450. The method of automatically activating those programs includes the method of regularly activating using the job scheduler, and activating in response to a certain event (for example, first registration of the data of new version, and excess of the disk usage of the database over the threshold value). According to the embodiment, the database server that stores multi-version time-series data may be configured to automatically minimize the disk usage of the database server by automatically deleting the data generated by the old analysis program. The working hours of the database managers for determining the data to be actually deleted may be made zero by automating activation of those programs. This may provide the effect of reducing the operational cost of the database that stores the time-series data. As a result, the time period for which the new and old processes are executed in parallel may be minimized. This makes it possible to minimize the CPU sources required for the analysis.

### Second Embodiment

The database server according to a second embodiment of the present invention will be described.

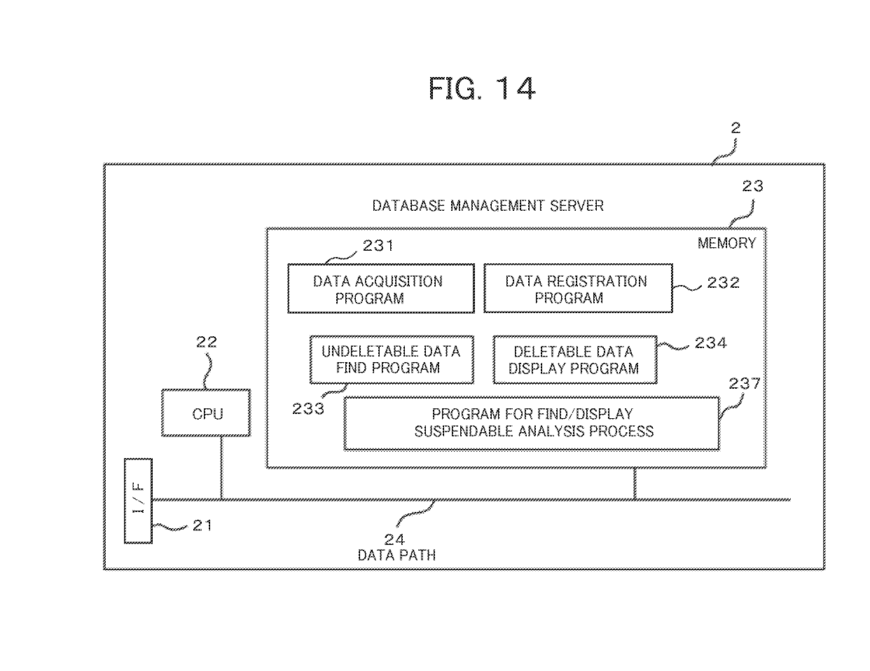

FIG. 14 is a functional block diagram illustrating an inner structure of the database management server according to the second embodiment. The inner structures of the database server and the database management server according to the second embodiment are the same as those of the first embodiment. However, this embodiment has a program for finding/displaying suspendable analysis process (suspendable analysis process find/display means) 237 in addition to the undeletable data find means 233 and the deletable data display means 234. The suspendable analysis program is presented to the database manager and the developer of the analysis program in addition to the deletable data.

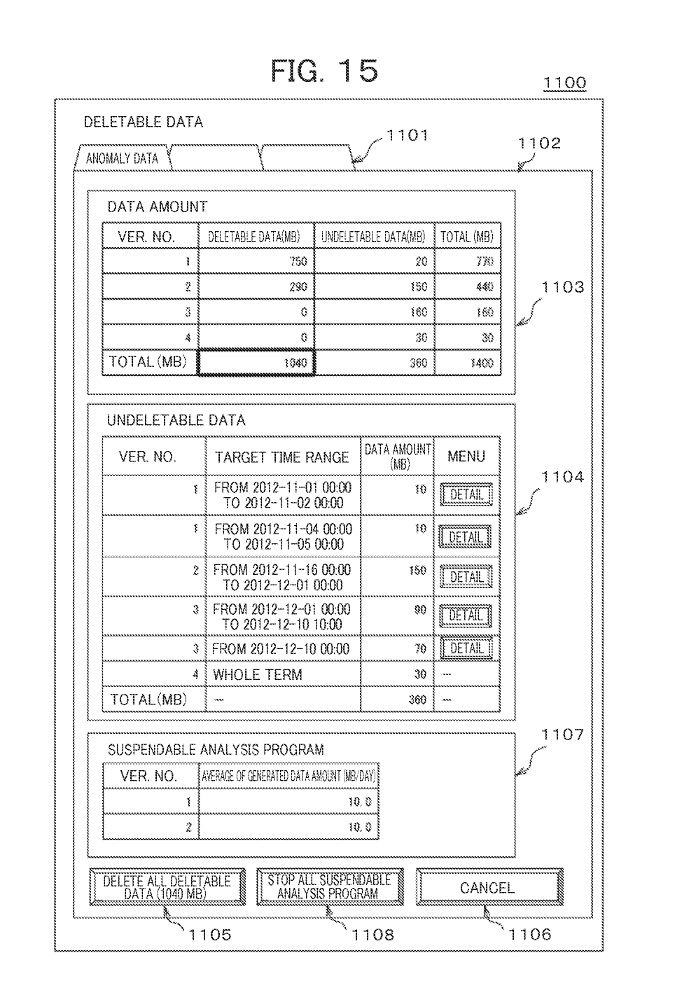

FIG. 15 is a view illustrating an example of the screen display 1100 through the deletable data display means 234 and the suspendable analysis process find/display means 237 according to the second embodiment. Elements designated with 1101 to 1106 are the same as those on the screen display (FIG. 12) according to the first embodiment.

A reference number 1107 denotes a region for displaying the suspendable version among the analysis programs.

This region displays the version number having no undeletable data 3400 existing for a predetermined term in the past from the current time (for example, one day). For example, referring to the example of FIG. 11, versions 1 and 2 have no undeletable data from 12/16 00:00 to 12/17 00:00. For that reason, the suspendable analysis process find/display means 237 displays the version numbers 1 and 2 as those of the suspendable analysis program.

A reference number 1108 denotes a button for collectively stop all the suspendable analysis programs. Upon depression of the button by the user, the suspendable analysis process find/display means 237 contacts the developer of the analysis program of the designated version, transmits a stop instruction to the analysis program of the designated version, or rejects registration of data from the analysis program of the designated version.

In the aforementioned manner, the suspendable analysis process find/display means 237 is allowed to present the database manager or the developer of the analysis program with the suspendable version among the analysis programs on the display screen. Functions of the suspendable analysis program find/display means 237 and the deletable data display means 234 may be combined to serve as the single deletable data display means 234.

The use of the information displayed on the display screen 1100 allows the database managers to minimize the amount of the data generated by the old analysis program on the database server. The database managers are also allowed to minimize the usage fee of the CPU source and network source necessary for operating the analysis program on the analysis server. It is also possible to reduce the working hours for determining the analysis program that is actually suspended by the database manager.

The undeletable data find means 233, the deletable data display means 234 and the suspendable analysis process find/display means 237 may be automatically activated. Those programs may be automatically executed up to the stop of the analysis program of old version. The method of automatically activating those programs includes the method of regularly activating using the job scheduler, and activating in response to a certain event (for example, first registration of the data of new version, and excess of the disk usage of the database over the threshold value). The automated activation of those programs may reduce the working hours for determining the analysis program actually stopped by the database manager to zero. This may provide the effect of reducing the operational cost of the database that stores the time-series data, and the analysis server for generating the time-series data.

### Third Embodiment

The database server according to a third embodiment of the present invention will be described.

The database server according to the third embodiment is the same as that of the first and the second embodiments. The inner structure of the database management server 2 of this embodiment is different from the one described in the first and the second embodiments.

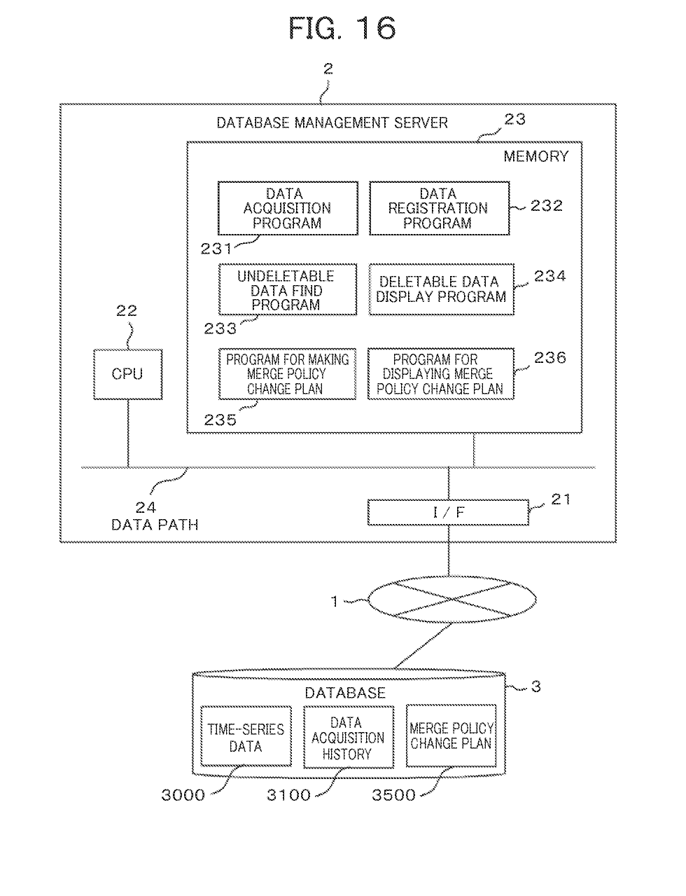

FIG. 16 is a functional block diagram showing the inner structure of the database management server according to the third embodiment. The database management server 2 transmits and receives packets via the interface (I/F) 21. The respective programs of the database management server 2 are stored in the memory 23. The memory 23 stores a merge policy change plan generation program 235 and a merge policy change plan display program 236 in addition to the same programs as those of the first embodiment. In operation of the database management server 2, the CPU 22 reads those programs through the data path 24 so as to be executed. Execution of those programs by the CPU 22 allows the database management server (computer) 2 to function as the search means (231), data registration means (232), undeletable data find means (233), deletable data display means (234), merge policy change plan generation means (235), and merge policy change plan display means (236).

The merge policy change plan generation means 235 is a program for generating the plan to change the merge policy designated by the analysis program (hereinafter referred to as merge policy change plan) by means of the undeletable data UDL and data acquisition pattern DRPL generated by the undeletable data find means 233. The merge policy change plan is a group including the past data acquisition request and the new merge policy corresponding to the data acquisition request. Change in two or more data acquisition requests may be contained in the single merge policy change plan. The merge policy change plan generation means 235 passes the generated merge policy change plan to the merge policy change plan display means 236.

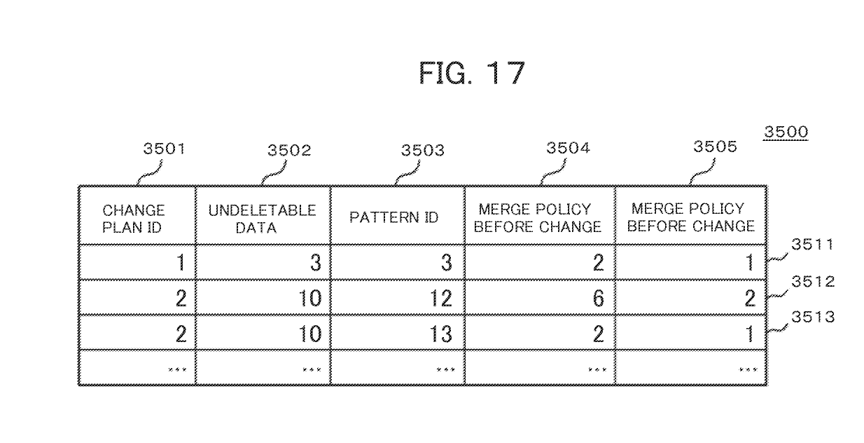

FIG. 17 represents an example of a merge policy change plan 3500. A column 3501 represents the identifier uniquely allocated to the respective merge policy change plans by the merge policy change plan generation means 235. A column 3502 represents ID of the undeletable data 3400 concerning the merge policy change plan. A column 3503 represents ID of the data acquisition pattern with possibility to change the merge policy. The merge policy change plan 3500 may store the data acquisition request instead of the pattern ID. A column 3504 represents the current merge policy corresponding to the data acquisition pattern in the column 3503. A column 3505 represents a new merge policy generated by the merge policy change plan generation means 235. When changing the current merge policy 2, that is, to “prioritize data of version existing for the longest term” in the search range to the merge policy 1, that is, to “prioritize the data of the latest version” in the search range, increase in the deletable data amount is expected. The increase in the deletable data amount may also be expected by changing the current merge policy 6 to the merge policy 2. The merge policy change plan generation means 235 generates the merge policy change plan based on the preliminarily set criteria such as reduction in the data amount.

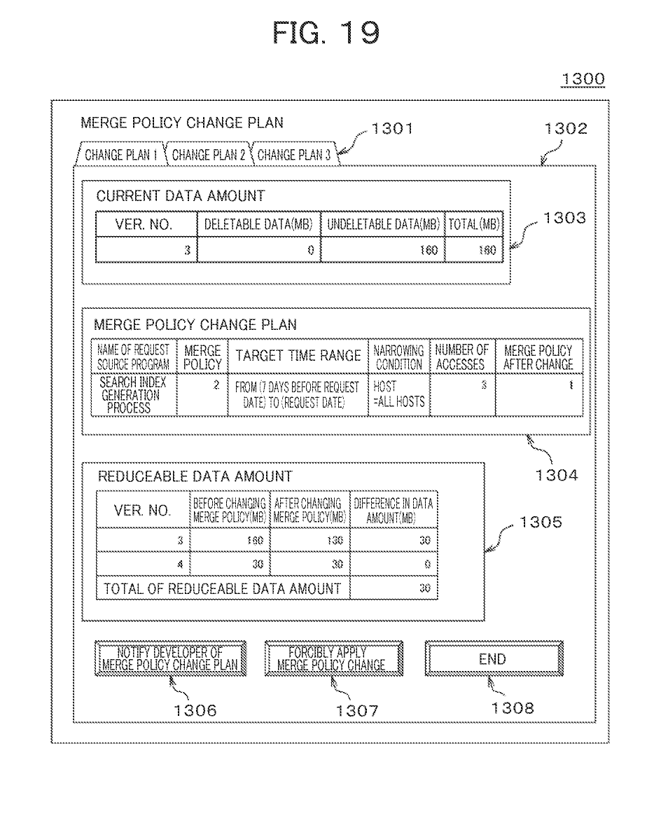

Based on the data generated by the merge policy change plan generation means 235, the merge policy change plan display means 236 presents the database manager or the developer of the analysis program with the merge policy change plan 3500 on a display screen 1300 (see FIG. 19). Alternatively, this program forcibly changes a part of the merge policy contained in the data acquisition request received by the search means 231 through the method of updating the set file of the search means 231.

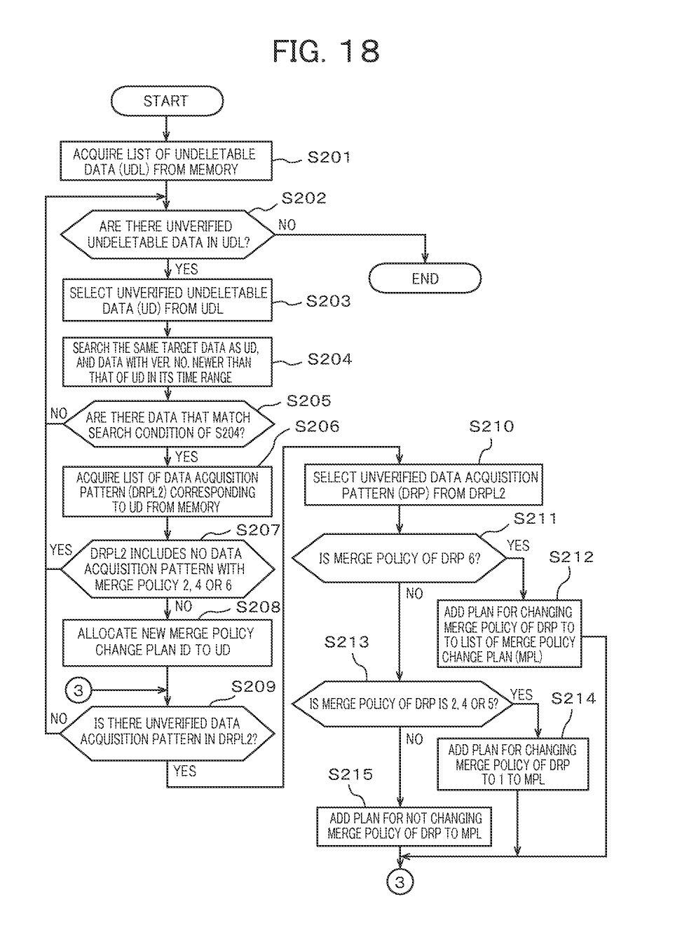

FIG. 18 is a flowchart of the process of generating the merge policy change plan, which is executed by the merge policy change plan generation means 235.

The merge policy change plan generation means 235 firstly acquires the list of the undeletable data 3400 generated by the undeletable data find means 233 (S201). The list will be referred to as UDL in the following description. The respective undeletable data 3400 contained in the UDL (hereinafter referred to as UD) are subjected to the process steps of S204 to S215 (S202 to S203).

The merge policy change plan generation means 235 searches with respect to existence of the same target data as the UD, and the data of version newer than the version number of the UD in its time range (S204). If no data that match the search conditions exist, generation of the merge policy change plan based on the UD is cancelled (S205). For example, if the row 3311 of the undeletable data 3300 shown in FIG. 8 is selected as the UD, no data of version newer than 1 exist between 11/1 00:00 and 11/2 00:00. Therefore, the merge policy change plan generation means 235 cancels generation of the merge policy change plan.

The merge policy change plan generation means 235 acquires the list having the undeletable data ID that match the UD from those of the data acquisition pattern generated by the undeletable data find means 233 (S206). In the following description, the acquired list of the data acquisition pattern will be referred to as DRPL2. If the DRPL2 does not contain any one of the data acquisition patterns 2, 4 and 6, generation of the merge policy change plan based on UD is canceled (S207). For example, if the row 3314 of the undeletable data 3300 shown in FIG. 8 is selected as the UD, the data acquisition patterns corresponding to the UD are those in rows 3414 and 3415 of the data acquisition pattern 3400 shown in FIG. 9. However, each of the data acquisition patterns has the merge policy 1. Accordingly, the merge policy change plan generation means 235 cancels generation of the merge policy change plan.

The merge policy change plan generation means 235 allocates the identifier for uniquely identifying the merge policy change plan to the UD that has passed the check (S208). Referring to the example of the undeletable data 3300 shown in FIG. 8, only the UD in the row 3313 passes the check. In the following description, it is assumed that the number 1 is allocated to the UD as the change plan ID.

In the following process, the respective data acquisition patterns (hereinafter referred to as DRP) contained in the DRPL2 are subjected to the process steps S211 to S215 (S209 to S210). The process is executed to change the merge policy with higher possibility to use the data of past version to the merge policy with lower possibility. For example, the merge policy 6 always prioritizes the same version as that of the data acquired in the past. However, there may be the case that the merge policy 2 prioritizes the data of newer version. Alternatively, there may be the case that the merge policy 2 prioritizes the data of the older version. Basically, the merge policy 1 always prioritizes the data of new version. Therefore the merge policy 6 uses the data of past version with the highest possibility among those of the embodiment. Meanwhile, the merge policy 1 uses such data with the lowest possibility. Merge policies 2, 4 and 5 are in the intermediate positions.

The merge policy change plan generation means 235 inspects whether the DRP merge policy is 6 (S211). In other words, it is inspected whether the DRP merge policy is specified to “prioritize the same version as that of the data acquired in the past”. If the DRP merge policy is 6, the plan for changing the DRP merge policy to 2 is added to the list of the merge policy change plan (MPL) on the memory (S212).

Then the merge policy change plan generation means 235 inspects whether the DRP merge policy is 2, 4 or 5 (S213). In other words, it is inspected whether the DRP merge policy is specified to “prioritize the data of version existing for the longest term over the data of the latest version”. If the DRP merge policy is 2, 4 or 5, the plan to change the DRP merge policy to 1 is added to MPL (S214). For example, the row 3511 of the merge policy change plan 3500 shown in FIG. 17 is generated from the row 3413 of the data acquisition pattern 3400 shown in FIG. 9.

If the DRP does not match any of the conditions as described above, the plan for not changing the DRP merge policy is added to the MPL (S215).

The process for generating the merge policy change plan, which is performed by the merge policy change plan generation means 235 has been summarized. The merge policy change plan generation means 235 passes the aforementioned MPL to the merge policy change plan display means 236.

In this embodiment, the plan for changing the merge policy 6 to 2, and the merge policies 2, 4, 5 to 1 is generated for the purpose of minimizing the influence of change in the merge policy on the subsequent process. If decrease in the data amount is required to be prioritized over the influence on the subsequent process, the merge policy change plan generation means 235 is allowed to generate the plan for changing the merge policy from 6 to 1.

FIG. 19 represents an example of the display screen 1300 of the merge policy change plan display means according to the third embodiment. A reference number 1301 denotes a tab indicating ID of the merge policy change plan. The number of the tabs to be displayed corresponds to that of the generated merge policy change plans. A reference number 1302 denotes the region that displays details of the merge policy change plan and the amount of data to be reduced in accordance with the change plan. When the user selects the tab 1301, the information concerning the merge policy change plan is displayed inside the frame 1302. A reference number 1303 denotes the region indicating the information of the undeletable data 3400 where the data amount may be reduced in accordance with the merge policy change plan. This region is generated based on the UDL. The amount of the deletable data 3450 and the undeletable data 3400 may be calculated through the same method as the one used by the deletable data display means 234. A reference number 1304 represents details of the merge policy change plan. In the region, the merge policy change plan with the same change plan ID as the one selected by the tab 1301 in the MPL is displayed. The merge policy change plan display means 236 may be configured to use the information contained in the DRPL to display the number of past accesses on the display screen 1300 through the data acquisition pattern as the information for judgment of the user. A reference number 1305 denotes the region for displaying the data amount that can be reduced in accordance with the merge policy change plan together with the version number. The data amount is calculated through the similar method to the one used by the deletable data display means 234. The region 1305 is allowed to display the term for the “data amount to be reduced” and the version information. A reference number 1306 denotes a button for notifying the developer of the analysis program of old version of the merge policy change plan. Upon depression of the button by the user, the merge policy change plan display means 236 notifies the developer of the analysis programs of all versions displayed on the region 1305 of the information via mail and the like. A reference number 1307 denotes a button for forcibly applying the merge policy change plan to the search means 231. A reference number 1307 denotes a button for closing the screen without notifying the merge policy change plan and forced application.

According to the embodiment, the tabs 1301 are displayed in order of the change plan ID. However, the merge policy change plan display means 236 may be configured to change the display order for assisting the user with selection of the merge policy change plan to be actually employed. For example, the merge policy change plan display means 236 is allowed to change the display order based on the following criteria:

In order of large data amount to be reduced;
In order of small number of data acquisition patterns requiring change in the merge policy;
In order of small number of analysis programs (request source program name) requiring change in the merge policy; and
In order of small total value of the number of accesses to the data acquisition pattern requiring change in the merge policy.
As described above, the merge policy change plan display means 236 is allowed to present the database managers with the modified plan of the merge policy contained in the data acquisition request which is displayed on the display screen 1300. The merge policy change plan display means 236 is allowed to present the database manager with the data amount that can be reduced through the modification on the display screen 1300.

The database managers are allowed to minimize the amount of data generated by the old analysis program on the database server. This also allows the developer of the analysis program to reduce the working hours for determining the method of changing the merge policy, and for modifying the analysis program in order to change the merge policy.

The undeletable data find means 233, the merge policy change plan generation means 235 and the merge policy change plan display means 236 may be automatically activated. Alternatively, those programs may be operated automatically up to application of the merge policy change plan. The method of automatically activating those programs includes the method of regularly activating using the job scheduler, and activating in response to a certain event (for example, first registration of the data of new version, and excess of the disk usage of the database over the threshold value). The automated activation of those programs allows the working hours for the developer of the analysis program to change the merge policy to be zero. This may provide the effect of reducing the operational cost of the analysis program.

The embodiments according to the present invention have been described in detail referring to the drawings. However, the specific structures are not limited to those described in the embodiment, and an arbitrary design may also be contained in the range without deviating from the scope of the invention.

### REFERENCE SIGNS LIST

1 network
2 database management server
21 I/F
22 CPU
23 memory
231 data acquisition program
232 data registration program
233 undeletable data find program
234 deletable data display program
235 merge policy change plan generation program
236 merge policy change plan display program
24 data path
3 database
3000 time-series data
3100 data acquisition history
3300 undeletable data
3400 data acquisition pattern
3450 deletable data
4 raw data generation server
5 analysis server
6 manager terminal
7 physical communication channel

1. A database server comprising:
a database capable of storing multi-version data with respect to various time-series data; and
a database management server for managing the database,
wherein the database management server includes search means capable of designating a merge policy defining a policy whether mixing of the multi-version data is acceptable in addition to a search condition of the database, and
the search means generates a result of merging the multi-version data in a time range contained in the search condition as a data acquisition history based on the designated merge policy, and records the data acquisition history in the database.

2. The database server according to claim 1, wherein the database management server calculates a version and the time range of the time-series data which are deletable in the time range contained in the search condition based on the data acquisition history, and outputs the calculation result.

3. The database server according to claim 2, wherein the merge policy is allowed to designate a priority given to any one of the data of the latest version and the data of version existing for the longest term in the time range contained in the search condition.

4. The database server according to claim 2, wherein the merge policy is allowed to designate with respect to a priority given to the same version as that of the data acquired in the past.

5. The database server according to claim 2, wherein in the case where the multi-version data are mixed in the search condition range, the merge policy is allowed to designate with respect to acceptance of merge of the multi-version data.

6. A database server comprising:
an analysis server which retains multi-version analysis programs;
a database allowed to store various time-series data corresponding to the multi-version analysis programs;
a database management server which manages the database; and
a manager terminal,
wherein the database management server includes:
search means capable of designating a merge policy defining a method of merging the multi-version data in addition to the search condition of the database;
undeletable data find means for finding undeletable time-series data; and
deletable data display means for displaying deletable data; the search means records a data acquisition history that contains the merge policy in a time range contained in the search condition with respect to the multi-version data;
the undeletable data find means calculates a version and a time range of the deletable time-series data based on the data acquisition history; and
the deletable data display means presents the manager terminal with the calculation result of the undeletable data find means.

7. The database server according to claim 6,
wherein the undeletable data find means calculates a data acquisition pattern common to a past data acquisition request as a reason for inability to delete the time-series data; and
the deletable data display means presents the manager terminal with the calculation result of the undeletable data find means.

8. The database server according to claim 6, wherein the database management server automatically deletes the time-series data which provide a result indicating ability of deleting.

9. The database server according to claim 6, wherein the database management server specifies a version of the suspendable analysis program based on the data acquisition history including the merge policy, and presents the manager terminal with the specified analysis program version.

10. The database server according to claim 6, wherein the database management server generates a change plan of a merge method allowed to reduce a usage of disk space based on the data acquisition history including the merge policy, and presents the manager terminal with the change plan of the merge method.

11. The database server according to claim 10, wherein the database management server automatically stops the analysis program of old version providing a result of suspendability, and automatically presents the manager terminal with the result of suspendability.

12. The database server according to claim 10,
wherein the merge policy is automatically changed with respect to a part of the data acquisition request sent from the analysis program based on the calculation result; and
a change plan of the analysis program associated with a change plan of the merge method is automatically presented to the manager terminal.

13. A database management method using a database management server,
wherein the database is allowed to store multi-version data with respect to various time-series data;
the database management server accepts designation of a merge policy defining a method of merging the multi-version data in addition to a search condition of the database;
a result of merging the multi-version data in a time range contained in the search condition is generated as a data acquisition history based on the designated merge policy;
the data acquisition history is recorded in the database; and
based on the data acquisition history, a version and a time range of the time-series data which are deletable are calculated, and the calculation result is presented to the manager terminal.

14. The database management method according to claim 13, wherein the database management server calculates a data acquisition pattern common to a past data acquisition request as a reason for inability to delete the time-series data based on the data acquisition history, and presents the manger terminal with the data acquisition pattern.

15. The database management method according to claim 13, wherein the database management server specifies the version of the suspendable analysis program based on the data acquisition history, and presents the manager terminal with the specified analysis program version.
